(19) United States
(12) Patent Application Publication
(10) Pub. No.: US 2015/0023665 A1
(43) Pub. Date: Jan. 22, 2015

(54) DYNAMIC CONTROL OF OPTICAL ATTENUATORS TO ENABLE IP MULTICAST

(71) Applicant: Telefonaktiebolaget L M Ericsson (Publ), Stockholm (SE)

(72) Inventors: Suresh KRISHNAN, Montreal (CA); Robert BRUNNER, Montreal (CA); Stephane LESSARD, Mirabel (CA)

(21) Appl. No.: 13/946,590

(22) Filed: Jul. 19, 2013

(51) Int. Cl. H04Q 11/00; H04L 12/18; H04L 12/761; H04J 14/02; H04L 12/721

(52) U.S. Cl. CPC H04Q 11/0005; H04J 14/021; H04J 14/0238; H04L 45/62; H04L 45/16; H04L 12/185
USPC 398/71

(57) ABSTRACT

Methods and systems for distributing multicast signals carried by an incoming light wave are disclosed. According to one aspect, the invention provides a method of controlling an optical device. The method includes dynamically controlling a plurality of optical attenuators of the optical device based on control signals indicative of changes to a multicast group.

### TECHNICAL FIELD

The present invention relates to optical switches and, more particularly, to optical switches configured to support Internet protocol (IP) multicast streams.

### BACKGROUND

IP multicast is a mechanism for delivering Internet protocol data to multiple interested receivers without sending redundant copies. IP multicast ideally scales to a large receiver population even with no prior knowledge of the number of receivers in the population. Multicast is being used as a preferred distribution mechanism for high-bandwidth streams such as broadcast video.

There are three fundamental types of IP addresses: unicast, broadcast, and multicast. The unicast address is designed to transmit an IP packet to a single destination. The broadcast address is used to send an IP datagram to an entire sub-network. The multicast address is designed to enable the delivery of IP datagrams to a set of hosts that have been configured as members of an IP multicast group in various scattered IP sub-networks. Individual hosts are free to join or leave a multicast group at any time. There are no restrictions on the physical location or the number of members of a multicast group. When a host joins a multicast group, and transmits a group membership protocol message for the group corresponding to a stream that it wishes to receive, the host sets its IP process and network interface card to receive IP packets addressed to the multicast group.

Multicast IP conserves bandwidth by forcing the network to perform packet replication only when necessary, and offers an attractive alternative to unicast transmission for the delivery of network streaming data.

Current optical switches cannot easily support IP multicast streams. Thus, conventionally, IP multicast streams are handled in the electrical plane of such switches rather than the optical plane. Therefore, the incoming optical signal must be converted to an electrical signal first. Then, the multicast routing operation is performed. Then, the electrical signal is converted back into an optical signal to be transferred to the outgoing ports. This conversion is problematic because conversion of signals from optical to electrical form and vice versa is very expensive, energy-inefficient, and slow.

### SUMMARY

Methods and systems for distributing multicast signals carried by an incoming light wave are disclosed. According to one aspect, the invention provides a method of controlling an optical device. The method includes generating control signals indicative of changes to a multicast group and dynamically controlling a plurality of optical attenuators of the optical device based on the control signals indicative of the changes to the multicast group. According to this aspect, in some embodiments, the method includes, responsive to a join command, altering at least one of the control signals so as to deactivate at least one of the plurality of optical attenuators. In some embodiments, the method includes, responsive to a leave command, altering at least one of the control signals so as to activate at least one of the plurality of optical attenuators.

According to another aspect, the invention provides a method for providing reconfigurable multicast distribution of data to dynamically change groups in an optical domain. The method includes receiving an incoming light wave carrying at least one multicast signal. The incoming light wave is split by a wavelength demultiplexer into a plurality of first light waves. Each of the first light waves propagates in a different path and has a different wavelength. Each wavelength corresponds to a different multicast group. Each of the first light waves is split into a first number of identical beams. The first number corresponds to a number of subscriber ports. The beams are selectively attenuated by way of optical attenuators based on destination to a particular subscriber port. The selective attenuation is determined by a predetermined multicast command. The beams from the optical attenuators are multiplexed and transmitted to the subscriber ports.

According to this aspect, in some embodiments, the number of multicast groups is an integer N and the number of subscriber ports is an integer M, where M is greater than N. In some embodiments, the plurality of optical attenuators are dynamically controlled by a controller. The controller receives at least one predetermined command indicating which of the subscriber ports within a multicast group is to receive the multicast signal. In some embodiments, the predetermined multicast command is a join command. In some embodiments, the predetermined command is a leave command and, in response to the leave command, an optical attenuator is activated to block a beam from transmission to a corresponding subscriber port. In some embodiments the method further includes storing a table that maps each different multicast group to a subscriber port. The table indicates which subscriber port is to participate in which multicast group and the table is updated upon receipt of a predetermined multicast command.

According to another aspect, the invention provides a reconfigurable optical router. The reconfigurable optical router includes a plurality of output ports. A wavelength demultiplexer is configured to split an incoming lightwave into a plurality of different light wave signals. Each light wave signal has a different wavelength corresponding to a different multicast group and propagates along a different physical path. In each physical path, a splitter is configured to split a light wave signal in the path into a plurality of beams. The number of beams is equal to a number of output ports of the router. In the path of each beam, an optical attenuator is configured to selectively attenuate corresponding beams. The optical attenuators are controlled to selectively attenuate the corresponding being according to whether the output port corresponding to the beam is part of the corresponding multicast group. A wavelength multiplexer is configured to multiplex the beams in the different physical paths to produce an output for each output port.

According to this aspect, in some embodiments, the number of optical attenuators is equal to a number of the output ports. In some embodiments, the reconfigurable optical router further includes a controller configured to control an amount of attenuation of each optical attenuator. In these embodiments, the controller may store a table that maps each different multicast group to the output ports. The table may indicate which output port is to participate in which multicast group. The table may be updated upon receipt of a predetermined multicast command. In some embodiments, the wavelength demultiplexer is a passive component. In some embodiments, the reconfigurable optical router further includes a controller configured to perform one of activation or deactivation of at least one optical attenuator in response to a multicast join and leave command. In some embodiments, the number of physical paths is at least as great as a specified number of multicast groups.

According to another aspect, the invention provides a method for distributing multicast signals carried by an incoming lightwave. The method includes splitting the incoming lightwave into a plurality of different light wave signals. Each lightwave signal propagates along a different physical path. There is a lightwave signal for each of at least one multicast group. Each lightwave signal is split into a plurality of beams. The number of beams corresponds to a number of subscriber ports. Each beam is passed to a different one of a plurality of optical attenuators. Each optical attenuator receives a control signal indicating whether a multicast signal carried by a beam received by the optical attenuator is destined to a particular subscriber port. The optical attenuator selectively attenuates beams according to the control signals based on participation in a corresponding multicast group.

According to this aspect, in some embodiments, the control signal provided to each optical attenuator is derived from a predetermined multicast command received from the subscriber port. In some embodiments, the number of subscriber ports exceeds a number of multicast groups. In some embodiments, the method further includes receiving a multicast command from at least one of the subscriber ports, and deriving the control signal for a corresponding optical attenuator from the multicast command. In some embodiments, the method further includes storing a table mapping multicast groups to subscriber ports. In these embodiments, the control signal is derived from the table and the table is updated based on receipt of the multicast command. Also, the multicast command may be a join command and the table may be updated to indicate participation in a multicast group and deactivation of the corresponding optical attenuator when a port issues the multicast join command. Also, the multicast command may be a leave command and the table may be updated to indicate removal from a multicast group and activation of the corresponding optical attenuator when a port issues the multicast leave command.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exemplary table relating multicast groups to optical output ports;

FIG. 2 is a block diagram of an optical router constructed in accordance with principles of the present invention;

FIG. 3 is a flowchart of an exemplary process for routing signals destined to different multicast groups by selective activation of optical attenuators; and

FIG. 4 is a flowchart of an exemplary process for routing signals destined to different multicast groups by selective activation of optical attenuators.

### DETAILED DESCRIPTION

Before describing in detail exemplary embodiments that are in accordance with the present invention, it is noted that the embodiments reside primarily in combinations of apparatus components and processing steps related to IP multicasting by an optical device. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Present embodiments include a mechanism by which multicast distribution to dynamically changing groups is provided in a purely optical domain, without incurring the overhead of any optical-electrical conversions of multicast signals. In particular, by multicasting entirely in the optical domain, the cost, energy inefficiency, and latency of electro-optical conversion is avoided.

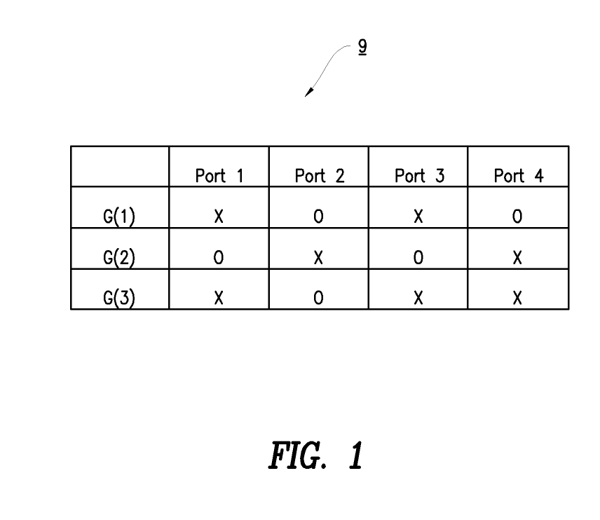

FIG. 1 is a table relating three multicast groups G(m) to four output ports of an optical device, such as an optical router. In the general case, an optical switch may have M multicast receiver ports and may receive N multicast streams. In some embodiments, M is greater than or equal to N. The table 9 shows as an example of three multicast groups mapped to four output ports of the optical device. In particular, for example, multicast group G(1) is selected for ports 1 and 3, multicast group G(2) is selected for port 2 and port 4, and multicast group G(3) is selected for port 1, port 3, and port 4. The table may be stored in a memory of a controller that controls optical attenuators of the optical device.

The table 9 may be updated by join and leave commands received from output ports of the optical device or from host devices associated with the output ports. As each port or associated host indicates an interest to receive a multicast stream by sending a join message for that specific IP multicast group, the table may be updated. Similarly, as each port or host device indicates an interest to cease receiving a multicast stream by sending a leave command for the specific IP multicast group, the table may be updated. In response to join and leave commands, the optical switch routes signals of the various multicast groups to the corresponding ports, as indicated by the table 9. In particular, optical attenuators of the optical switch are activated and deactivated in response to join and leave commands received by a controller of the optical switch to control which output ports of the optical switch receive an IP multicast signal.

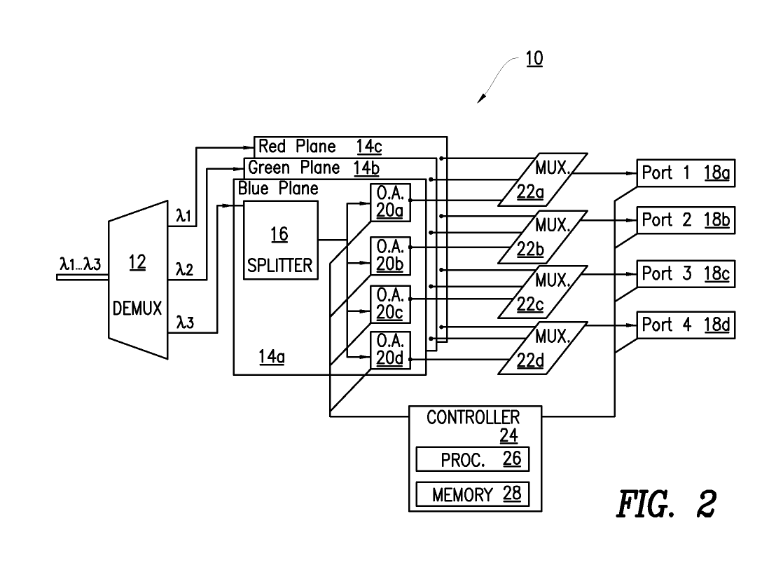

FIG. 2 is a block diagram of an optical router 10 constructed in accordance with principles of the present invention. An incoming lightwave carrying at least one multicast signal is received by a wavelength demultiplexer 12. The demultiplexer 12 may be a passive or active component. The wavelength demultiplexer 12 splits the incoming lightwave into a plurality of first light waves, each of the first light waves having a different wavelength. Each wavelength corresponds to a different multicast group.

Thus, the demultiplexer 12 may split the incoming light wave signal into as many paths as there are different multicast groups. In other words, each of the first light waves propagates in a different path as a consequence of the wavelength demultiplexing. Thus, each of the first light waves are dumultiplexed to lie in a different plane 14a, 14b and 14c, referred to collectively herein as planes 14. For example, the plane 14 may include plane 14a corresponding to a blue wavelength, plane 14b corresponding to a green wavelength and plane 14c corresponding to a red wavelength. Each of planes 14 has its own splitter 16 and optical attenuators 20. Each of the different light waves in each plane 14 are split by a splitter 16 into a first number of identical beams, lying in their respective planes 14a, 14b, and 14c. The number of identical beams in each plane corresponds to a number of subscriber ports 18a, 18b, 18c, and 18d, referred to herein collectively as ports 18.

In each plane, each identical beam is coupled to a different one of a plurality of optical attenuators 20a, 20b, 20c and 20d, referred to herein collectively as optical attenuators 20. An optical attenuator is a device used to reduce the power level of an optical signal in response to an electrical signal. An electrical signal may activate the optical attenuator 20 to block light from passing through it and an electrical signal may deactivate the optical attenuator to allow light to pass there through. The beams are selectively attenuated by way of the optical attenuators 20, based on a destination to a particular subscriber port 18. The selective attenuation is determined by a predetermined multicast command. The beams received from the optical attenuators 20 are multiplexed by multiplexers 22a, 22b, 22c, and 22d, referred to herein collectively as multiplexers 22, and transmitted to the subscriber ports 18.

The optical attenuators 20 are controlled by a controller 24. The controller 24 sends an electrical signal to each optical attenuator 20 to activate or deactivate the optical attenuator 20 according to which subscriber ports 18 are to receive the beam coupled to the respective optical attenuator 20. The controller 24 may include a processor 26 and a memory 28. The processor 26 generates signals to control the optical attenuators 20 according to a table 9, such as the table of FIG. 1, stored in the memory 28, that maps multicast groups to output ports 18. The table 9 stored in the memory 28 is updated to reflect join and leave commands received from ports 18 or received from a host device (not shown) associated with a corresponding port 18. Note that the memory 28 may also store computer instructions that, when executed by the processor 26, cause the processor to perform the functions described herein. Note further that the embodiments are not limited to four optical attenuators, four output ports and three wavelengths. In general, there may be as many wavelengths as there are multicast groups and as many optical attenuators as there are output ports, subject of course to processing, memory and size limitations. The invention is not limited to the embodiments shown herein.

For example, suppose a first multicast signal corresponding to a first multicast group is to be routed to port 4 18d based on a join command received from port 4 18d. The wavelength demultiplexer 12 routes the incoming light wave signal to different planes 14, each plane corresponding to a different wavelength, each wavelength corresponding to a different multicast group. For example, suppose that the first multicast group is associated with the blue plane 14a. The signal in the blue plane 14a is divided into 4 beams, each beam corresponding to a different output port 18. Assume that the multicast signal is only to be routed to output port 4 18d. In this case, control signals are routed to each of the optical attenuators 20 in the blue plane 14a. Since, in this example, the first multicast signal is to be routed only to port 4 18d, only the optical attenuator in the blue plane 14a coupled to port 4 18d is deactivated, and the remainder of optical attenuators 20 in the blue plane 14a are activated to block the beam received by each respective optical attenuator 20.

Thus, when a multicast signal is to be routed to a particular one of output ports 18, the particular one of output ports 18 sends a join command to the controller 24. In response to receiving the join command, the processor 26 updates the table 9 stored in the memory 28. Further, the processor 26 generates a control signal to deactivate the optical attenuator corresponding to the particular multicast group and the particular one of the output ports to pass the signal received by that optical attenuator. When a multicast signal is to be no longer routed to a particular one of the output ports 18, such as when a leave command is received from a host or corresponding port, the particular one of the output ports or hosts sends a leave command to the controller 24. In response to receiving the leave command, the processor 26 updates the table 9 stored in the memory 28. Further the processor 26 generates a control signal to activate the optical attenuator 20 corresponding to the particular multicast signal and the particular one of the output ports 18 to which the leave command corresponds to block the signal received by that optical attenuator 20.

Thus, the plurality of optical attenuators 20 are dynamically controlled by a controller 24. The controller 24 receives at least one predetermined multicast command indicating which of the subscriber ports 18 within a multicast group is to receive a multicast signal. The predetermined multicast command may be a join command or leave command, such as an IP multicast join or leave command. In response to a join command from a particular port 18 or corresponding host requesting to receive a particular multicast signal, the controller issues a signal deactivating the optical attenuator 20 corresponding to the particular port and the particular multicast signal. In response to a leave command from a particular port 18 requesting to no longer receive a particular multicast signal, the controller issues a signal activating an optical attenuator 20 corresponding to the particular port 18 and the particular multicast signal.

The status of join and leave commands may be stored in a table of a memory 28 accessible by the processor 26 of the controller 24. Thus, the controller 24 is configured to control an amount of attenuation of each optical attenuator 20. More particularly, the controller 24 may activate or deactivate an optical attenuator 20 to block or unblock a beam received by the optical attenuator 20 in response to a join or leave command.

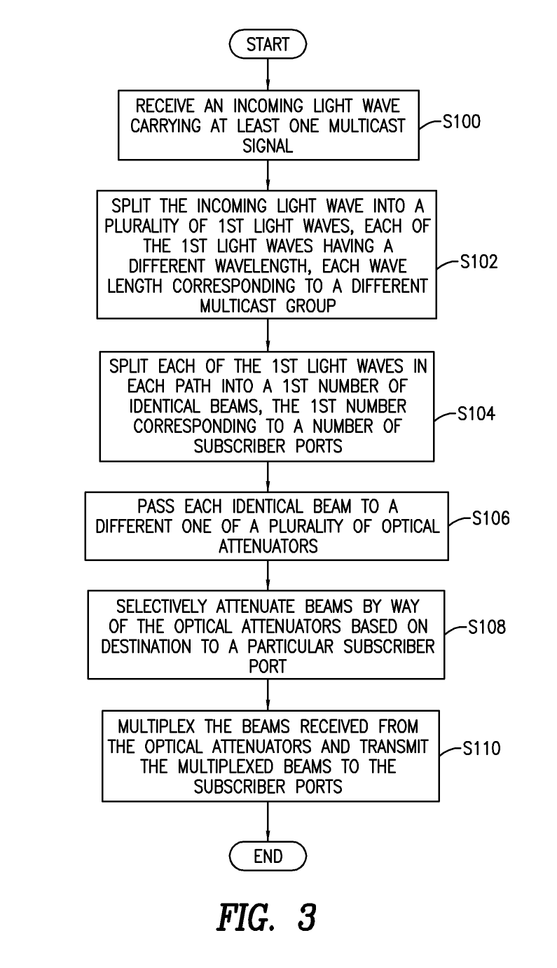

An exemplary process for routing signals destined to different multicast groups by selective activation of optical attenuators 20 is described with reference to FIG. 3. An incoming light wave carrying at least one multicast signal is received at a wavelength demultiplexer 12 (block S100). The incoming lightwave is split by the demultiplexer 12 into a plurality of first light waves. Each of the first light waves has a different wavelength. Each wavelength corresponds to a different multicast group (block S102). Each of the first light waves in its respective plane is split into a first number of identical beams by a splitter 16. The first number of identical beams corresponds to a number of subscriber ports 18 (block S104). Each identical beam is passed to a different one of a plurality of optical attenuators 20 (block S106). The beams are selectively attenuated by way of the optical attenuators 20 based on destination to a particular subscriber port 18 (block S108). For example, the attenuation may be selected based on join or leave commands stored in the table 9 of the memory 28 of the controller 24. The beams received from the optical attenuators 20 are multiplexed by a multiplexer 22 and transmitted to the subscriber ports 18 (block S110).

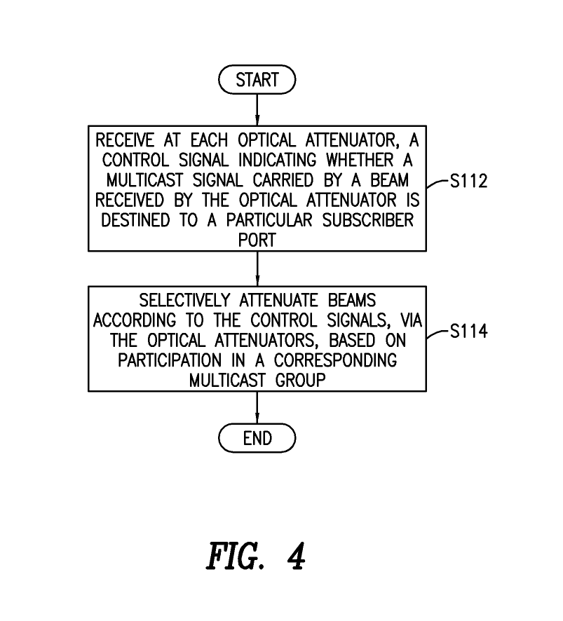

FIG. 4 is another flowchart of an exemplary process for routing signals destined to different multicast groups by selective activation of optical attenuators 20. Each of a plurality of optical attenuators 20 receives a control signal indicating whether a multicast signal carried by a beam received by the optical attenuator 20 is destined to a particular subscriber port 18 (block S112). The beams at each optical attenuator 20 are selectively attenuated according to the control signals based on participation in a corresponding multicast group (block S114). For example, responsive to a join command, the control signals may be altered so as to deactivate at least one of the plurality of optical attenuators 20. Similarly, responsive to a leave command, the control signals may be altered so as to activate at least one of the plurality of optical attenuators 20.

By selectively attenuating beams corresponding to a particular multicast group and a particular output port, IP multicasting may be achieved entirely in the optical domain, without conversion of the IP multicast signal to the electrical domain and vice versa. IP multicasting entirely in the optical domain results in lower cost, increased energy efficiency, and faster speeds. Thus, the allocation of multicast messages to multicast groups can be performed dynamically in the optical domain “on the fly.”

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for providing reconfigurable multicast distribution of data to dynamically change groups in an optical domain, the method comprising:
receiving an incoming light wave carrying at least one multicast signal;
splitting, via a wavelength demultiplexer, the incoming light wave into a plurality of first light waves, each of the first light waves propagating in a different path and having a different wavelength, each wavelength corresponding to a different multicast group;
splitting each of the first light waves in each path into a first number of identical beams, the first number corresponding to a number of subscriber ports;
passing each identical beam to a different one of a plurality of optical attenuators;
selectively attenuating beams, via the optical attenuators, based on destination to a particular subscriber port, the selective attenuation determined by a predetermined multicast command;
multiplexing the beams received from the optical attenuators; and
transmitting the multiplexed beams to the subscriber ports.

2. The method of claim 1, wherein the number of multicast groups is an integer N and the number of subscriber ports is an integer M, where M is greater than N.

3. The method of claim 1, wherein the plurality of optical attenuators are dynamically controlled by a controller, the controller receiving at least one predetermined multicast command indicating which of the subscriber ports within a multicast group is to receive the multicast signal.

4. The method of claim 1, wherein the predetermined multicast command is a join command.

5. The method of claim 1, wherein, the predetermined command is a leave command, and wherein in response to the leave command, an optical attenuator is activated to block a beam from transmission to a corresponding subscriber port.

6. The method of claim 1, further comprising storing a table, the table mapping each different multicast group to the subscriber ports, the table indicating which subscriber port is to participate in which multicast group, the table being updated upon receipt of a predetermined multicast command.

7. A reconfigurable optical router, comprising:
a plurality of output ports;
a wavelength demultiplexer configured to split an incoming light wave into a plurality of different light wave signals, each light wave signal having a different wavelength corresponding to a different multicast group and propagating along a different physical path;
in each physical path, a splitter configured to split a light wave signal in the path into a plurality of beams, the number of beams being equal to a number of output ports of the router;
in the path of each beam, an optical attenuator configured to selectively attenuate a corresponding beam, the optical attenuator being controlled to selectively attenuate the corresponding beam according to whether the output port corresponding to the beam is part of the corresponding multicast group; and.
a wavelength multiplexer configured to multiplex the beams in the different physical paths to produce an output for each output port.

8. The reconfigurable optical router of claim 6, wherein the number of optical attenuators is equal to a number of the output ports.

9. The reconfigurable optical router of claim 6, further comprising a controller configured to control an amount of attenuation of each optical attenuator.

10. The reconfigurable optical router of claim 9, wherein the controller stores a table, the table mapping each different multicast group to the output ports, the table indicating which output port is to participate in which multicast group, the table being updated upon receipt of a predetermined multicast command.

11. The reconfigurable optical router of claim 6, wherein the wavelength demultiplexer is a passive component.

12. The reconfigurable optical router of claim 6, further comprising a controller configured to perform one of activation or deactivation of at least one optical attenuator in response to a multicast join and leave command.

13. The reconfigurable optical router of claim 6, wherein the number of physical paths is at least as great as a specified number of multicast groups.

14. A method for distributing multicast signals carried by an incoming light wave, the method comprising:
splitting the incoming light wave into a plurality of different light wave signals, each light wave signal propagating along a different physical path, there being a light wave signal for each of at least one multicast group;
splitting each light wave signal into a plurality of beams, the number of beams corresponding to a number of subscriber ports;
passing each beam to a different one of a plurality of optical attenuators:
receiving at each optical attenuator, a control signal indicating whether a multicast signal carried by a beam received by the optical attenuator is destined to a particular subscriber port; and
selectively attenuating beams according to the control signals, via the optical attenuators, based on participation in a corresponding multicast group.

15. The method of claim 14, wherein the control signal provided to each optical attenuator and is derived from a predetermined multicast command received from a subscriber port.

16. The method of claim 14, wherein a number of subscriber ports exceeds a number of multicast groups.

17. The method of claim 14, further comprising receiving a multicast command from at least one of the subscriber ports, and deriving the control signal for a corresponding optical attenuator from the multicast command.

18. The method of claim 17, further comprising storing a table mapping multicast groups to subscriber ports, wherein the control signal is derived from the table, the table being updated based on receipt of the multicast command.

19. The method of claim 18, wherein the multicast command is a join command, and wherein the table is updated to indicate participation in a multicast group and deactivation of the corresponding optical attenuator when a port issues the multicast join command.

20. The method of claim 19, wherein the multicast command is a leave command and wherein the table is updated to indicate removal from a multicast group and activation of the corresponding optical attenuator when a port issues the multicast leave command.

21. A method of controlling an optical device, the method comprising:
generating controls signals indicative of changes to a multicast group;
dynamically controlling a plurality of optical attenuators of the optical device based on the control signals indicative of the changes to the multicast group.

22. The method of claim 21, further comprising altering at least one of the control signals, so as to deactivate at least one of the plurality of optical attenuators in response to a join command.

23. The method of claim 21, further comprising altering at least one of the control signals, so as to activate at least one of the plurality of optical attenuators in response to a leave command.
